(19) United States
(12) Patent Application Publication
(10) Pub. No.: US 2018/0291604 A1
(43) Pub. Date: Oct. 11, 2018

(54) Drainer Using Height Adjustable Basket to Adjust Height of Floating Body

(71) Applicant: Yan LI, Shanghai (CN)

(72) Inventor: Yan LI, Shanghai (CN)

(21) Appl. No.: 15/698,566

(22) Filed: Sep. 7, 2017

(30) Foreign Application Priority Data
Apr. 5, 2017 (CN) 201710219016.5

(51) Int. Cl. E03C 1/282; F16K 1/14; F16K 31/20

(52) U.S. Cl. CPC E03C 1/282; F16K 31/20; F16K 1/14

(57) ABSTRACT

This invention discloses a drainer that uses height-adjustable basket to control the height of floating body. It is characterized in that the drainer includes body, height-adjustable basket, floating body and water-saving component. The drainer body comprises a water inlet, inner cavity of drainer body, height adjustment column and the water outlet. The height-adjustable basket, floating body and water-saving component are alternately set in the drainer body, and the water-saving component is closer to the water outlet.

### BACKGROUND OF THE PRESENT INVENTION

### Field of Invention

This is an invention of kitchen and bath supplies, especially related to the drainer that uses basket type to adjust the height of floating body.

### Description of Related Arts

In modern family, the drainer in vegetable washing sink or washbasin is a small object, but its effect on the indoor health environment cannot be overlooked. At present, there are all kinds of drainers on the market. Although they have the function of draining and sealing, they usually need manual operation to play a role of anti-smell-returning. Users may often forget to seal, thus indoor air will be polluted. Furthermore, for the efficient use of water resources, the water-saving requirements are also taken into consideration in the improvement of the drainer, so as to achieve the purpose of environmental protection. In view of this, the technicians in this field are dedicated to developing water-saving drainer with automatic anti-smell-returning function.

### SUMMARY OF THE PRESENT INVENTION

In order to realize above purpose, this invention provides a drainer that uses basket type to adjust the height of floating body. It is characterized in that; the drainer includes body, basket type, floating body and water-saving component. The drainer body comprises a water inlet, inner cavity of drainer body, height adjustment column and the water outlet. The basket type, floating body and water-saving component are alternately set in the drainer body, and the water-saving component is closer to the water outlet. The basket type comprises a floating body cavity, filter hole and height adjustment groove. The water-saving component include drain hole of water-saving component, so as to form a circulation channel sequentially through the water inlet, inner cavity of drainer body, basket type filter hole, floating body, drain hole of water-saving component and the drain hole. The floating body is movably set up in the upper part of the water-saving component and suitable for sealing the drain hole of water-saving component. The basket type prescribes a limit to the active portion of floating body. When the basket type rotates downward to press or upwards to break away from the floating body, the floating body will complete the opening and closing of the water-saving component drain hole inside the floating body cavity.

Further, the pore diameter of the water-saving component's drain hole is less than that of the drainer body's water outlet.

Further, the height adjustment column should be located at the bottom or lateral of drainer body's inner cavity.

Further, the height adjustment groove should be located at the bottom or lateral of basket type and correspond with the position of height adjustment column. When the height adjustment groove of basket type moves up and down along the height adjustment column, and when the basket type rotates downward to press or upwards to leave the floating body, the floating body will complete the opening and closing of the water-saving component's drain hole inside the floating body cavity.

Further, the floating body adopts sphere, ellipsoid, cube, cuboid, cylinder or cone.

For the invented drainer that uses basket type to adjust the height of floating body, it has under-mentioned functions.

When using the water, the floating body floats upward and opens the water outlet automatically. When water is gone, the floating body goes down and automatically seals the water outlet. With simple structure and good sealing effect, it overcomes some shortcomings of traditional drainers, for example, traditional drainers have no anti-smell-returning function or need to be manually closed to achieve this purpose.

To match the external water outlet pipe, the diameter of existing drainer's water outlet is generally larger. When users open the tap and the water flow is strong, generally they cannot realize that there is no need of strong water flow (since the drainer cannot play the role of reminder). After appropriate water-saving component's drain hole is adopted (the diameter size of drain hole matches medium water yield of tap), when users use the tap and the water flow is larger than medium water yield, due to the throttling effect of water-saving component's drain hole, the water will overflow the drainer, and then it will remind users of strong water flow of tap, which need turning down, so to realize water-saving and achieve the purpose of environmental protection.

The following shall be combined with appended drawings to further explain the design, the concrete structure, and the generated technical effect of this invention, to fully comprehend the purpose, characteristics and effect of this invention.

This summary presented above is provided merely to introduce certain concepts and not to identify any key or essential features of the claimed subject matter.

### BRIEF DESCRIPTION OF THE DRAWINGS

FIG. 1 is the schematic diagram of a preferred embodiment of the present invention.

FIG. 2 is the schematic view of drainer body in FIG. 1.

FIG. 3 is the top view of FIG. 2.

FIG. 4 is the sectional view of the A-A direction in FIG. 3.

FIG. 5 is the schematic view of basket type in FIG. 1.

FIG. 6 is the top view of FIG. 5.

FIG. 7 is the sectional view of the B-B direction in FIG. 6.

FIG. 8 is the schematic diagram of water-saving component in FIG. 1.

FIG. 9 is the schematic diagram of drainer when basket type adjusts the height of floating body during water remains.

FIG. 10 shows the schematic diagram of drainer when basket type adjusts the height of floating body in C-C direction in FIG. 6 during water flow.

FIG. 11 is the schematic diagram of a handle's pull-up structure from another preferred embodiment of the present invention.

FIG. 12 is the schematic diagram of the structure when the handle in FIG. 11 presses down.

### DETAILED DESCRIPTION OF THE PREFERRED EMBODIMENT

In the Instruction Book of implementation mode for this invention, what need to understand is that, the orientations or positional relations indicated by the term “Up”, “Down”, “Front”, “Back”, “Left”, “Right” “Vertical”, “Horizontal”, “Top”, “Bottom”, “Inside”, “Outside”, “Clockwise” “Counterclockwise” are the ones based on appended drawings, which is only to facilitate the Instruction Book of this invention and simplify the Instruction Book, but not to indicate or suggest that the mentioned devices or components must have specific orientations, and get constructed and operated in specific orientations, so all above cannot be regarded as limiting this invention. The appended drawings are schematic or conceptual graphs, so for the relation between the thickness and width of each part, and the proportion relation among the parts, etc., they are not completely consistent with the actual values.

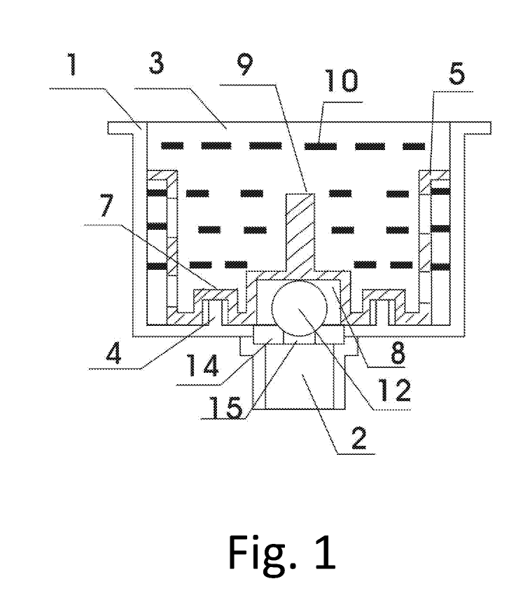

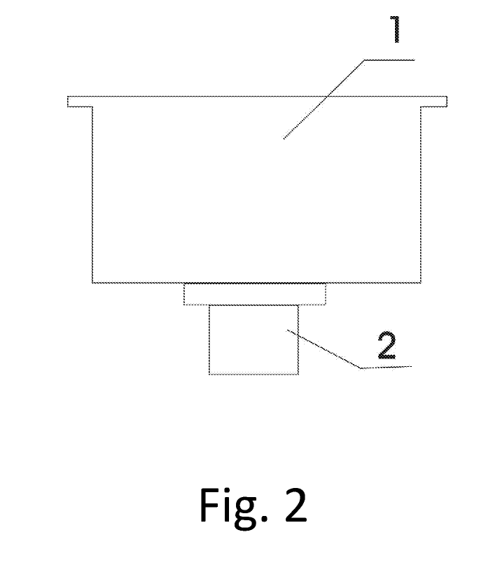

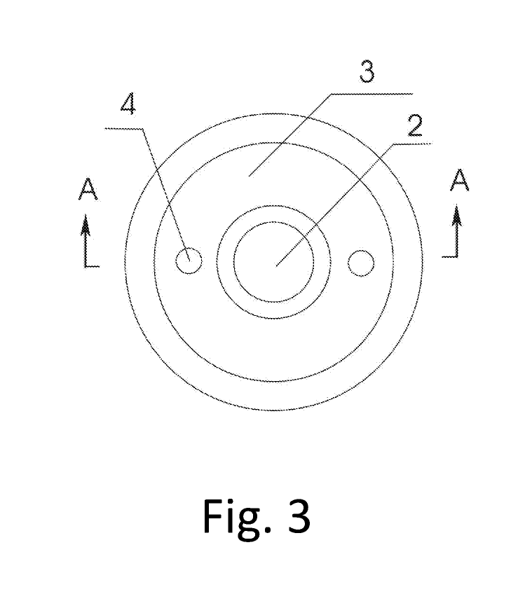

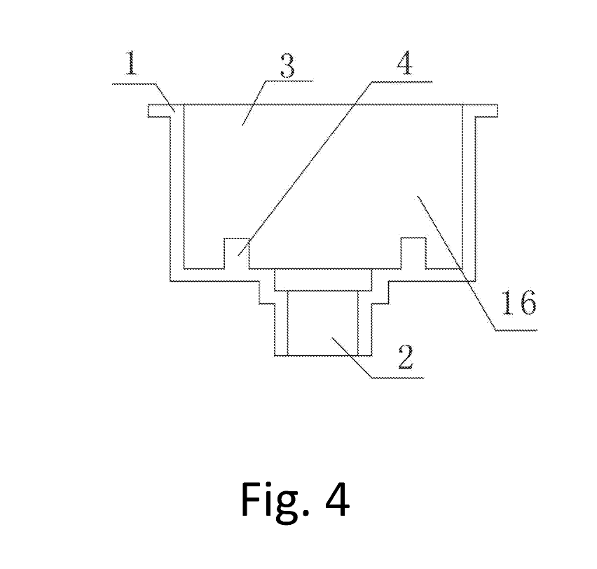

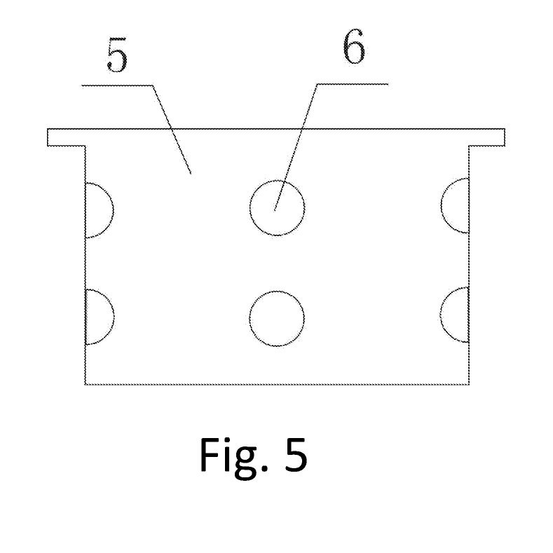

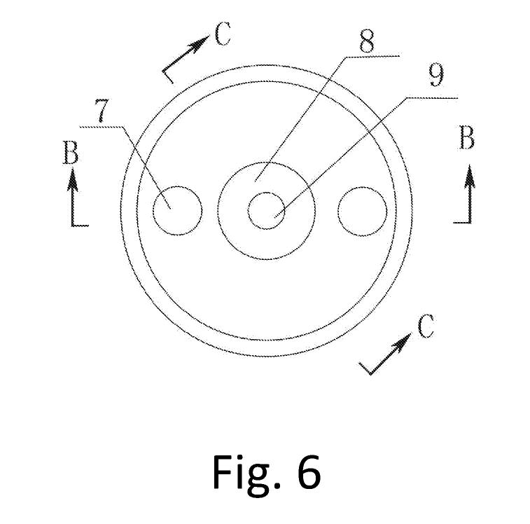

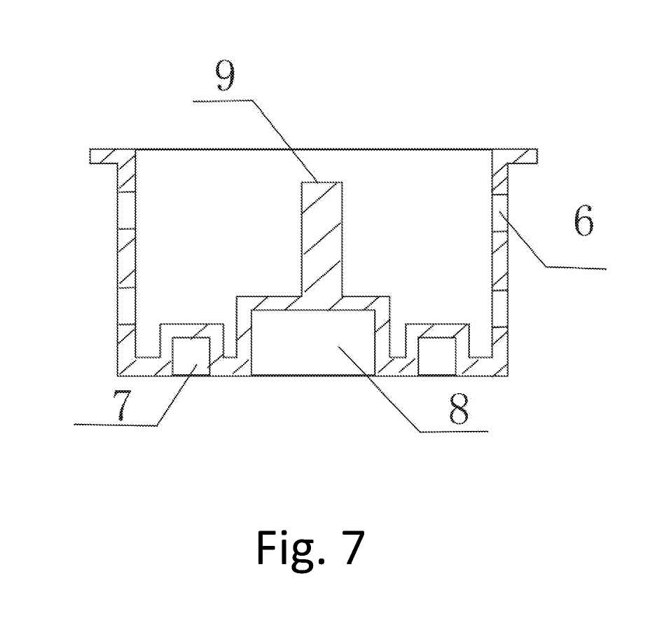

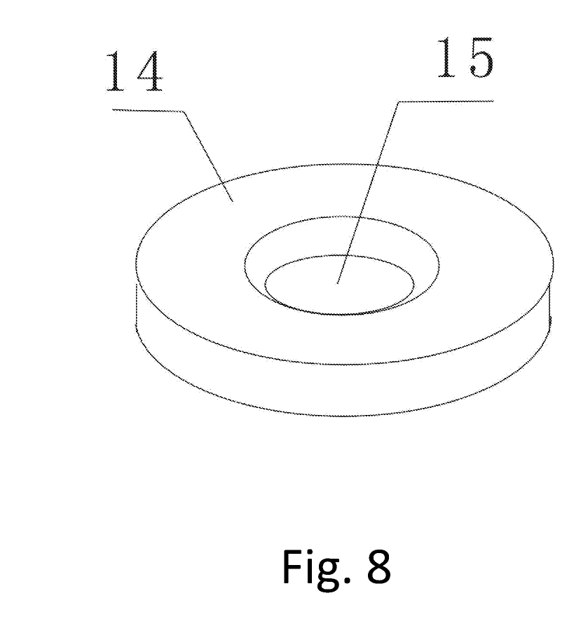

As shown in FIG. 1 to FIG. 12, it is a drainer that utilizes basket type to adjust the height of floating body from our examples. It includes drainer body 1, basket type 5, floating body 12, and water-saving component 14. The drainer body 1 comprises water inlet 3, a water inner cavity 16 of drainer body, height adjustment column 4 and water outlet 2. Basket type 5 and water-saving component 14 are arranged at intervals inside the drainer body 1; water-saving component 14 is closer to the water outlet 2.

The basket type 5 includes filter hole 6, floating body cavity 8, water-saving to component 14 and water-saving component's drain hole 15, so as to form a circulation channel sequentially through the water inlet 3, inner cavity 16 of drainer body, basket type filter hole 6, floating body 12, water-saving component 14, drain hole 15 the water outlet 2.

The shape of basket type 5 restricts the floating body cavity 8 which faces water-saving component 14, and floating body 12 is arranged between basket type 5 and water-saving component 14, while floating body cavity 8 restricts the active portion of floating body 12; under the condition without water, the floating body 12 falls upon water-saving component 14, and its shape and size are sufficient to seal water-saving component's drain hole 15, so as to close the sewer; when the buoyancy effect of floating body 12 leaves water-saving component 14 and goes deep into floating body cavity 8, namely opening water-saving component's drain hole 15, so as to achieve the opening on 15, and then the water flow 11 goes downward through the drainer water outlet 2.

In this case, the floating body 12 can also be used with sphere, ellipsoid, cube, cuboid, cylinder or cone, as long as they can meet the opening and closing of water-saving component's drain hole 15.

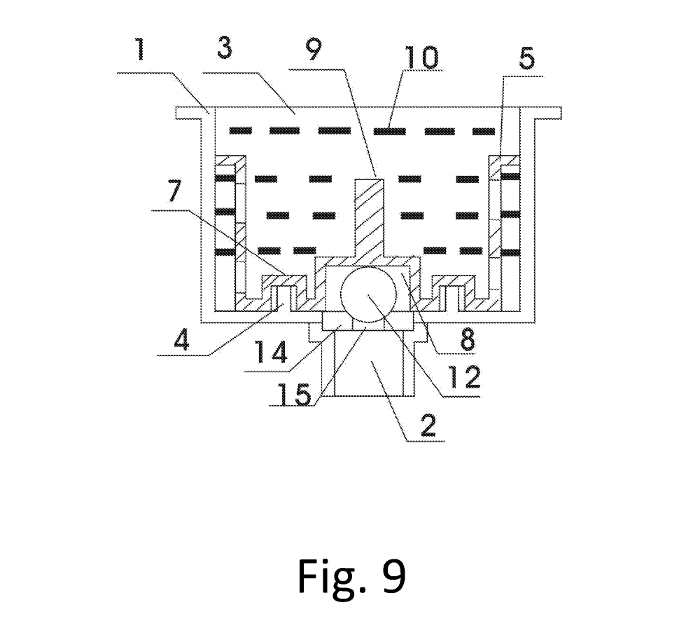

As shown in FIG. 9, there is a height adjustment column at the bottom of inner cavity 16 of drainer body. The position corresponding to height adjustment column 4, there is a height adjustment groove 7 at the bottom of basket type 5. When the water tank needs water remain 10, the basket type's height adjustment groove 7 should be correspondingly placed on height adjustment column 4. When basket type 5 overall goes down, and floating body cavity 8 pushes floating body 12 onto water-saving component 14, the floating body 12 will play closure effect on water-saving component's drain hole. At this moment, the water remains 10 accumulates on water-saving component 14, thus the water remain 10 cannot flow down and the water tank cannot save water 10.

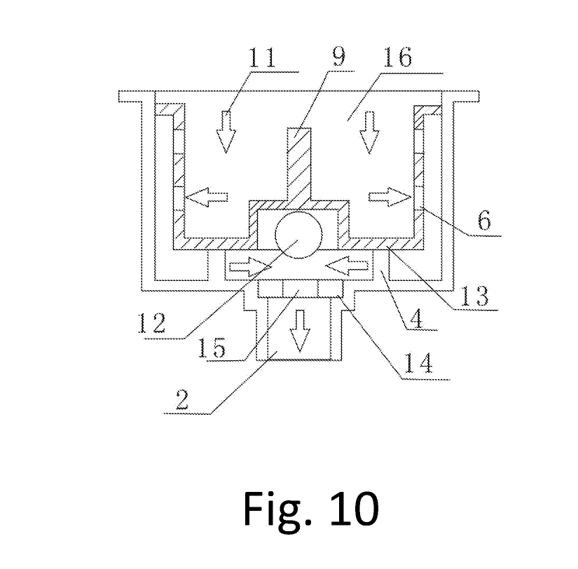

As shown in FIG. 10, the handle 9 lifts height adjustment groove 7 which will leave height adjustment column 4. The basket type 5 rotates at certain angle and sets down. The positions of height adjustment groove 7 and height adjustment column 4 do not correspond to each other. The height adjustment column 4 supports the basket type′ bottom plane 13. After the basket type 5 overall moves up, the floating body cavity 8 leaves floating body 12. When the water flow 11 enters inner cavity of drainer body 16, and the floating body 12 floats with the effect of water flow, the water-saving component's drain hole 15 will be opened. Later, the water flow 11 goes through the water-saving component's drain hole 15 and then drainer water outlet 2 and finally the external drainage pipeline.

The diameter of water-saving component's drain hole 15 is less than that of drainer water outlet 2 (the diameter size of drain hole 15 matches medium water yield of tap), when the water flow is larger than medium water yield, due to the throttling effect of water-saving component's drain hole 15, the water will overflow the drainer, and then it will remind users of strong water flow of tap, so as to achieve the purpose of environmental protection.

When there is no water flow 11, the floating body 12 will fall under the influence of own gravity force, and play closure effect on water-saving component's drain hole 15, preventing the foul smell from rising in the external drain pipe, thus to achieve the goal of automatic anti-smell-returning.

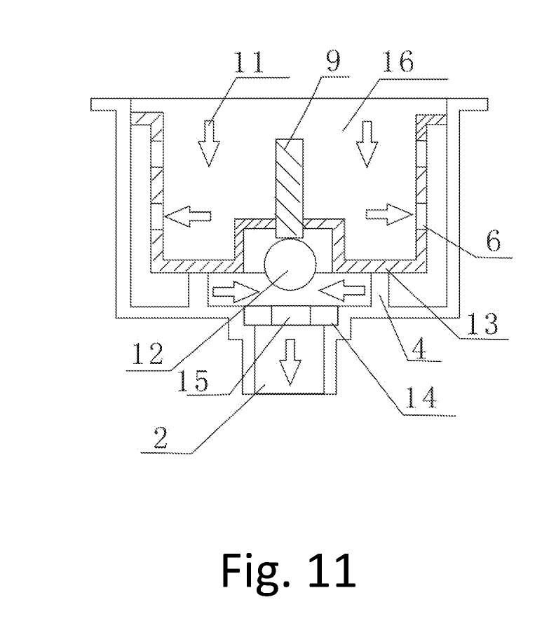

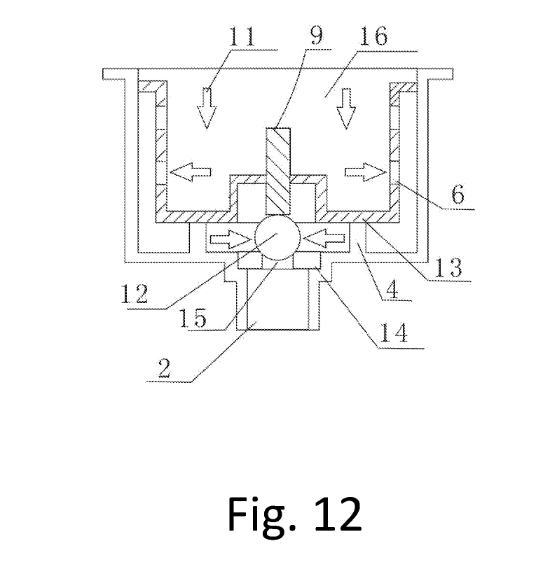

FIG. 11 and FIG. 12 is another preferred embodiment of the present invention. The major difference from the first case lies in that the height adjustment groove 7 is canceled, and the bottom plane of basket type is placed at the top of height adjustment column 4; handle 9 is an independent component, which is inserted at the upper of the floating body cavity 8 and can be moved up and down manually. When the handle 9 is pulled along the floating body cavity 8, and the floating body 12 rises, the water flows through the water-saving component's drain hole 15; when the handle 9 is pressed downward into the floating body 8 and contacts floating body 12, the water-saving component's drain hole 15 will be closed and save water.

The above has in detail described some relatively excellent cases of this invention. It should be understood that one skilled in the art do not need creative work and can make many modifications and changes according to the conception of this invention. Therefore, the technical scheme created by all technical staff in this technical field in accordance with the idea of this invention and on the basis of the existing technology through logical analysis and reasoning or limited experiment should be in the scope of protection determined by the claims presented below.

What is claimed is:

1. A drainer, comprising:
a body;
a height-adjustable basket;
a floating body; and
a water-saving component, wherein the drainer body comprises a water inlet, an inner cavity of drainer body, a height adjustment column and a water outlet, wherein the basket, the floating body and the water-saving component are alternately set in the drainer body, and the water-saving component is closer to the water outlet.

2. The drainer, as recited in claim 1, wherein the basket comprises a floating body cavity, a filter hole and at least one of height adjustment grooves, which prescribes a limit to the active portion of floating body by rotating downward to press or upwards to break away from the floating body, the floating body will complete the opening and closing of the water-saving component drain hole inside the floating body cavity.

3. The drainer, as recited in claim 1, wherein the water-saving component comprises a drain hole of water-saving component to form a circulation channel sequentially through the water inlet, the inner cavity of the drainer body, the basket filter hole, the floating body, and the drain hole.

4. The drainer, as recited in claim 1, wherein the floating body is movably disposed in the upper part of the water-saving component to control the opening or sealing the drain hole of water-saving component.

5. The drainer, as recited in claim 3, wherein the pore diameter of the water-saving component's drain hole is less than that of the drainer body's water outlet.

6. The drainer, as recited in claim 1, wherein the height adjustment column is located at the bottom or lateral of drainer body's inner cavity.

7. The drainer, as recited in claim 2, wherein the height adjustment groove is located at the bottom or lateral of the basket, which corresponding with the position of height adjustment column to control the opening and closing of the water-saving component's drain hole inside the floating body cavity.

8. The drainer, as recited in claim 4, wherein the floating body adopts the shape selected form the group consisting of sphere, ellipsoid, cube, cuboid, cylinder, cone, or combination thereof.
